(19) United States
(12) Patent Application Publication
(10) Pub. No.: US 2025/0216691 A1
(43) Pub. Date: Jul. 3, 2025

(54) OPTICAL STRUCTURE, DISPLAY DEVICE AND DEPOLARIZATION BEAM SPLITTING STRUCTURE

(71) Applicants: Beijing Zitiao Network Technology Co., Ltd., Beijing (CN); Lemon Inc., Grand Cayman (KY)

(72) Inventors: Shaopeng ZHU, Beijing (CN); Ziyang ZHANG, Los Angeles, CA (US); Jian CHEN, Beijing (CN); Xuan ZHONG, Beijing (CN); Wenbin BAI, Beijing (CN); Guojun LIU, Beijing (CN)

(21) Appl. No.: 18/999,611

(22) Filed: Dec. 23, 2024

(30) Foreign Application Priority Data
Dec. 28, 2023 (CN) 202311837851.7

(51) Int. Cl. G02B 27/28; G02B 17/08

(52) U.S. Cl. CPC G02B 27/283; G02B 17/0804; G02B 17/0856

(57) ABSTRACT

An optical structure, a display device and a depolarization beam splitting structure. The optical structure has a light incident side and a light-exiting side; and the optical structure includes a lens structure, a beam splitting film, a light-transmitting protective film, a phase retardation film and a polarizing reflective film. The lens structure includes a first surface and a second surface, the beam splitting film is located on a side of the first surface; the light-transmitting protective film is located on a side of the beam splitting film away from the first surface and in contact with the beam splitting film. The beam splitting film includes a metal layer; the light-transmitting protective film includes a structure layer; a refractive index of the structure layer gradually decreases along a reference direction; and the reference direction is a direction in which the beam splitting film points towards the light-transmitting protective film.

### CROSS-REFERENCE TO RELATED APPLICATION

The present application claims priority of Chinese Patent Application No. 202311837851.7, filed on Dec. 28, 2023, the disclosure of which is incorporated herein by reference in its entirety as part of the present application.

### TECHNICAL FIELD

Embodiments of the present disclosure relate to an optical structure, a display device and a depolarization beam splitting structure.

### BACKGROUND

Among devices for virtual reality (VR) and mixed reality (MR), a near-eye display device enlarges an image of a display screen through lenses, giving people a sense of immersion. At present, there are two main lens technologies: Fresnel lens and Pancake lens (ultra-short focal length folded optical path). Wherein the Pancake lens greatly reduces a distance required between the near-eye display device and human eyes through a folded optical path, making a VR device and an MR device thinner and lighter.

### SUMMARY

At least one embodiment of the present disclosure provides an optical structure, having a light incident side and a light-exiting side, including: a lens structure, including a first surface and a second surface arranged opposite to each other; the first surface being a surface of the lens structure on the light incident side, and the first surface being a curved surface; a beam splitting film, located on a side of the first surface away from the second surface; a light-transmitting protective film, located on a side of the beam splitting film away from the first surface and in contact with the beam splitting film; a phase retardation film, located on a side of the second surface away from the first surface; and a polarizing reflective film, located on a side of the second surface away from the first surface, wherein the beam splitting film includes a metal layer; the light-transmitting protective film includes a structure layer; a refractive index of the structure layer gradually decreases along a reference direction; and the reference direction is a direction in which the beam splitting film points towards the light-transmitting protective film.

For example, in the optical structure according to an embodiment of the present disclosure, the light-transmitting protective film further includes a base layer; the base layer is closer to the beam splitting film than the structure layer; and the base layer is in contact with the beam splitting film and is configured to protect the beam splitting film.

For example, in the optical structure according to an embodiment of the present disclosure, a refractive index of the base layer is not less than a maximum refractive index of the structure layer.

For example, in the optical structure according to an embodiment of the present disclosure, the structure layer includes a plurality of protruding structures; and along the reference direction, dimensions of cross-sectional line segments of a longitudinal section of each of the plurality of protruding structures gradually decreases, and a direction of each of the cross-sectional line segments is perpendicular to the reference direction, the longitudinal section is parallel to the reference direction.

For example, in the optical structure according to an embodiment of the present disclosure, a lateral side of the longitudinal section of each of the plurality of protruding structures includes at least one of a straight line segment or a curved line segment.

For example, in the optical structure according to an embodiment of the present disclosure, a maximum height of each of the plurality of protruding structures in the reference direction ranges from 50 nm to 200 nm; and a minimum spacing distance between two adjacent ones of the plurality of protruding structures ranges from 0 nm to 200 nm.

For example, in the optical structure according to an embodiment of the present disclosure, the refractive index of the structure layer decreases step by step along the reference direction, and includes at least 3 decreasing steps.

For example, in the optical structure according to an embodiment of the present disclosure, the structure layer includes at least three structure sub-layers; the at least three structure sub-layers are sequentially arranged along the reference direction; and refractive indices of the at least three structure sub-layers sequentially decrease along the reference direction.

For example, in the optical structure according to an embodiment of the present disclosure, material densities of the at least three structure sub-layers sequentially decrease along the reference direction.

For example, in the optical structure according to an embodiment of the present disclosure, each of the at least three structure sub-layers includes a nanoparticle coating; and porosities of the at least three structure sub-layers sequentially increase along the reference direction.

For example, in the optical structure according to an embodiment of the present disclosure, a material of the base layer of the light-transmitting protective film includes at least one selected from the group consisting of acrylic, polyurethane, epoxy, amino resin, polyester resin, organosilicon, parylene and derivatives thereof, plasma-polymerized hexamethyldisiloxane, polytetrafluoroethylene, and polyvinylidene fluoride; and a material of the structure layer of the light-transmitting protective film includes at least one selected from the group consisting of acrylic acid, polyurethane, epoxy, amino resin, polyester resin, organosilicon, parylene and derivatives thereof, plasma-polymerized hexamethyldisiloxane, polytetrafluoroethylene, and polyvinylidene fluoride.

For example, in the optical structure according to an embodiment of the present disclosure, a thickness of the base layer ranges from 100 nm to 5 μm; and a thickness of the structure layer ranges from 50 nm to 200 nm.

For example, in the optical structure according to an embodiment of the present disclosure, the beam splitting film further includes at least one non-metal layer stacked with the metal layer.

For example, the optical structure according to an embodiment of the present disclosure further including a polarized absorption film, located on a side of the polarizing reflective film away from the first surface.

At least one embodiment of the present disclosure provides a display device, including a display screen and the optical structure described above, wherein the display screen is located on the light incident side of the optical structure.

For example, in the display device according to an embodiment of the present disclosure, the display screen includes a micro organic light emitting diode display screen.

At least one embodiment of the present disclosure provides a depolarization beam splitting structure, including a beam splitting film and a light-transmitting protective film stacked with each other; wherein the light-transmitting protective film is provided in contact with the beam splitting film; the beam splitting film includes a metal layer and at least one non-metal layer stacked with the metal layer; the light-transmitting protective film includes a structure layer; a refractive index of the structure layer gradually decreases along a reference direction; and the reference direction is a direction in which the beam splitting film points towards the light-transmitting protective film.

For example, in the depolarization beam splitting structure according to an embodiment of the present disclosure, the light-transmitting protective film further comprises a base layer; the base layer is closer to the beam splitting film than the structure layer; and the base layer is in contact with the beam splitting film and is configured to protect the beam splitting film, a refractive index of the base layer is not less than a maximum refractive index of the structure layer.

For example, in the depolarization beam splitting structure according to an embodiment of the present disclosure, the structure layer comprises a plurality of protruding structures; and along the reference direction, dimensions of cross-sectional line segments of a longitudinal section of each of the plurality of protruding structures gradually decreases, and a direction of each of the cross-sectional line segments is perpendicular to the reference direction, the longitudinal section is parallel to the reference direction.

For example, in the depolarization beam splitting structure according to an embodiment of the present disclosure, the refractive index of the structure layer decreases step by step along the reference direction, and comprises at least 3 decreasing steps, the structure layer comprises at least three structure sub-layers; the at least three structure sub-layers are sequentially arranged along the reference direction and refractive indices of the at least three structure sub-layers sequentially decrease along the reference direction.

### BRIEF DESCRIPTION OF DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a structural schematic diagram of a display device;

FIG. 2 is a structural schematic diagram of another display device;

FIG. 3 is a curve chart of reflectances and transmittances of a medium beam splitter for light incident at different incident angles;

FIG. 4 is a cross-sectional schematic diagram of an optical structure provided by an embodiment of the present disclosure;

FIG. 5 is a partially enlarged cross-sectional schematic diagram of an optical structure illustrated by FIG. 4;

FIG. 6 is another partially enlarged cross-sectional schematic diagram of an optical structure illustrated by FIG. 4;

FIG. 7 is a curve chart of reflectances and transmittances of a beam splitter film provided by an embodiment of the present disclosure for light incident at different incident angles;

FIG. 8 is a partially enlarged cross-sectional schematic diagram of a beam splitting film provided by an embodiment of the present disclosure after coating with a protective layer;

FIG. 9 is a curve chart of reflectances and transmittances of a beam splitting film and a protective layer illustrated by FIG. 8 for light incident at different incident angles;

FIG. 10 is another curve chart of reflectances and transmittances of a beam splitting film and a protective layer illustrated by FIG. 8 for light incident at different incident angles;

FIG. 11 is a schematic diagram of one type of refractive index variation of a structure layer of a light-transmitting protective film provided by an embodiment of the present disclosure;

FIG. 12 is another partially enlarged cross-sectional schematic diagram of a light-transmitting protective film provided by an embodiment of the present disclosure;

FIG. 13 is another partially enlarged cross-sectional schematic diagram of a light-transmitting protective film provided by an embodiment of the present disclosure;

FIG. 14 is another partially enlarged cross-sectional schematic diagram of a light-transmitting protective film provided by an embodiment of the present disclosure;

FIG. 15 is a schematic diagram of another type of refractive index variation of a structure layer of a light-transmitting protective film provided by an embodiment of the present disclosure;

FIG. 16 is another partially enlarged cross-sectional schematic diagram of a beam splitting film and a light-transmitting protective film of an optical structure provided by an embodiment of the present disclosure;

FIG. 17 is a schematic diagram of refractive indices of a beam splitting film and a light-transmitting protective film illustrated by FIG. 16;

FIG. 18 is a curve chart of reflectances and transmittances of a beam splitter film and a light-transmitting protective film illustrated by FIG. 16 for light incident at different incident angles;

FIG. 19 is a partially enlarged cross-sectional schematic diagram of a beam splitting film provided by an embodiment of the present disclosure after coating with a protective layer;

FIG. 20 is a curve chart of reflectances and transmittances of a beam splitting film and a protective layer illustrated by FIG. 19 for light incident at different incident angles;

FIG. 21 is another partially enlarged cross-sectional schematic diagram of a beam splitting film and a light-transmitting protective film of an optical structure provided by an embodiment of the present disclosure;

FIG. 22 is a schematic diagram of refractive indices of a beam splitting film and a light-transmitting protective film illustrated by FIG. 21;

FIG. 23 is a curve chart of reflectances and transmittances of a beam splitting film and a light-transmitting protective film illustrated by FIG. 21 for light incident at different incident angles;

FIG. 24 is another partially enlarged cross-sectional schematic diagram of a beam splitting film and a light-transmitting protective film of an optical structure provided by an embodiment of the present disclosure;

FIG. 25 is a cross-sectional schematic diagram of a display device provided by an embodiment of the present disclosure; and

FIG. 26 is a partially enlarged cross-sectional schematic diagram of a depolarization beam splitting structure provided by an embodiment of the present disclosure.

### DETAILED DESCRIPTION

In order to make the objectives, technical solutions, and advantages of the embodiments of the present disclosure clearer, the technical solutions of the embodiments of the present disclosure will be clearly and completely described below in conjunction with the accompanying drawings of the embodiments of the present disclosure. It is apparent that the described embodiments are part of the embodiments of the present disclosure, not all of the embodiments. Based on the described embodiments of the present disclosure, all other embodiments obtained by those skilled in the art without creative labor are within the scope of protection of the present disclosure.

Unless otherwise defined, technical terms or scientific terms used in this disclosure shall have the usual meaning understood by those of ordinary skill in the art to which this disclosure belongs. The use of the words “first”, “second”, and similar words in this disclosure does not indicate any order, quantity, or importance, but is only used to distinguish different components. The words “including” or “comprising” and similar words mean that the elements or objects appearing before the word cover the elements or objects listed after the word and their equivalents, without excluding other elements or objects. The words “connected” or “connecting” and similar words are not limited to physical or mechanical connections, but can include electrical connections, whether direct or indirect.

Unless otherwise defined, the features of “parallel”, “vertical” and “identical” used in the embodiments of the present disclosure include the strict sense of “parallel”, “vertical” and “identical”, as well as the situations involving certain errors such as “substantially parallel”, “substantially vertical” and “substantially identical”. For example, the above-mentioned “substantially” can indicate that the difference value of the compared object is within 10% or 5% of the average value of the compared object. When the number of a component or element is not specifically indicated in the following embodiments of the present disclosure, it means that the component or element can be one or more, or can be understood as at least one. “At least one” refers to one or more, and “more than one” refers to at least two. The “arranged in the same layer” in the embodiments of the present disclosure refers to the relationship between multiple film layers formed by the same material after the same step (e.g., a one-step patterning process). Here, “in the same layer” does not always refer to the thickness of multiple film layers being the same or the height of multiple film layers being the same in the cross-sectional view.

Pancake lens technology has become the mainstream lens technology for virtual reality and mixed reality near-eye display systems, which is adopted by respective virtual reality and mixed reality near-eye display manufacturers. A Pancake lens usually includes a lens and a transflective film, a phase retardation film, a polarizing reflective film, and a polarized absorption film formed on the lens. The transflective film may simultaneously reflect and transmit light, for example, the transflective film may be a semi-transmissive and semi-reflective film. The phase retardation film has a fast axis and a slow axis, which may convert light in a circularly polarized state into light in a linearly polarized state, or convert light in a linearly polarized state into light in a circularly polarized state. The polarizing reflective film has a reflection axis and a transmission axis, reflects linearly polarized light whose polarization direction is parallel to a direction of the reflection axis while keeping a polarized state of the linearly polarized light unchanged, and transmits linearly polarized light whose polarization direction is parallel to a direction of the transmission axis while keeping a polarized state of the linearly polarized light unchanged. The polarized absorption film has a transmission axis; a transmission axis direction of the polarized absorption film is parallel to the transmission axis of the polarizing reflective film; and the fast axis of the phase retardation film is at a 45-degree or 135-degree angle to the transmission axis of the polarizing reflective film.

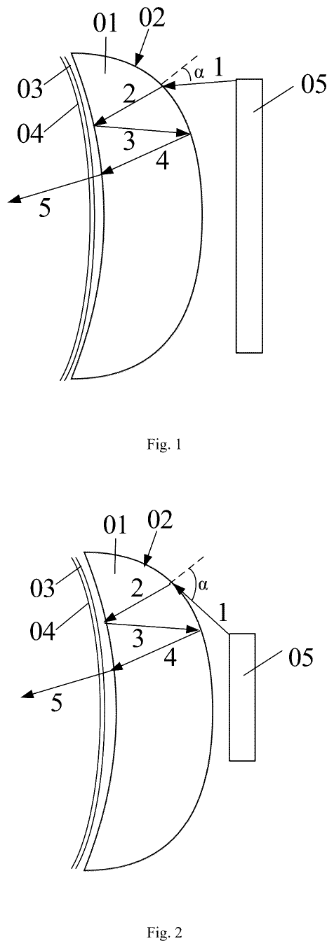

FIG. 1 is a structural schematic diagram of a display device. As illustrated by FIG. 1, the display device includes a Pancake lens and a display screen 05; the Pancake lens includes a lens 01, a beam splitter 02, a quarter wave plate 03, and a polarizing reflective film 04. The beam splitter 02 is located on a curved surface of the lens 01 close to the display screen 05; the quarter wave plate 03 may change a polarized state of light, converting circularly polarized light and linearly polarized light into each other; the polarizing reflective film 04 is located on a surface of the lens 01, and the polarizing reflective film 04 may transmit polarized light in one direction (e.g., S light) and reflect polarized light in another direction (e.g., P light). Light emitted by the display screen 05 is folded through the Pancake lens, which greatly reduces a distance required between the near-eye display device and the human eyes.

For the Pancake lens, the key to forming a folded optical path is mutual conversion between circularly polarized light and linearly polarized light, and an ellipticity of the circularly polarized light within the folded optical path is an important physical quantity that determines optical quality of the Pancake lens. When the ellipticity is 1, it represents that the polarized light is fully circularly polarized light; when the ellipticity is 0, it represents that the polarized light is fully linearly polarized light; and when the ellipticity is between 0 and 1, it represents elliptically polarized light. The closer it is to 1, the closer it is to the circularly polarized light. A principle of the Pancake lens requires that the ellipticity of the circularly polarized light within the folded optical path (e.g., paths 2, 3 and 4 illustrated by FIG. 1) should be as close to 1 as possible. If the ellipticity is low, a portion of light may not follow the designed folded optical path, resulting in stray light or ghosting, which affects optical quality of imaging.

For the Pancake lens, the primary determinant of the ellipticity is the quarter wave plate (QWP). An ideal QWP requires that when the linearly polarized light is incident at a 45-degree angle to an optical axis thereof, a retardation of the linearly polarized light is exactly ¼ of a wavelength thereof, then circularly polarized light with an ellipticity of 1 may be formed; if the retardation is lower or higher than ¼ of the wavelength, elliptically polarized light with an ellipticity lower than 1 may be formed.

For the Pancake lens, other determinant of the ellipticity further includes material of the lens. The Pancake lens requires the material of the lens to have an extremely low birefringence; otherwise, a phase of the polarized light when the polarized light passes through the lens may be delayed due to a birefringence characteristic of the lens, which affects the ellipticity and distribution thereof.

However, for the Pancake lens, there is always another overlooked determinant that affects the ellipticity, that is, the beam splitter. The traditional beam splitter is plated with 6 to 10 layers of medium film to implement a specific transmittance and reflectance (e.g., the transmittance and the reflectance being respectively 50%). However, according to an optical characteristic of the medium film of the beam splitter, when light is incident obliquely, an S-polarized component and a P-polarized component thereof relative to an incident surface are inconsistent in reflectance, and the S-polarized component and the P-polarized component thereof relative to the incident surface are also inconsistent in transmittance. That is to say, when fully circularly polarized light is incident obliquely to the surface of the beam splitter, both transmitted light and reflected light may become elliptically polarized light, that is, the ellipticity will decrease.

In the existing VR device based on a Pancake lens, a screen of a near-eye display module is a liquid crystal display (LCD), for example, a typical size of the liquid crystal display is 2 inches or more, and a size of the screen is equivalent to a size of the lens. For example, as illustrated by FIG. 1, a surface of the display screen 05 is arranged with a wave plate to emit circularly polarized light; when the circularly polarized light is incident to the beam splitter of the Pancake lens, an incident angle α of the circularly polarized light is relatively small, for example, the incident angle α is smaller than 20 degrees; in a case where the incident angle α is relatively small, a difference between transmittance Tp of the P-polarized component and transmittance Ts of the S-polarized component of the medium beam splitter 02 is not large, so, decrease in ellipticity is also not large.

FIG. 2 is a structural schematic diagram of another display device. As illustrated by FIG. 2, when the display screen 05 of the display device is a screen with a relatively small size such as a micro organic light emitting diode (microOLED) display screen, since the size of the lens 01 needs to match a viewing angle of the human eye, and the size of the lens 01 cannot be proportionally reduced with the size of the display screen 05, the size of the display screen 05 may be much smaller than the size of the lens 01. At this time, when circularly polarized light emitted from the display screen 05 through the wave plate is incident onto the beam splitter 02 on the lens 01, a part of the circularly polarized light has a relatively large incident angle α, for example, the incident angle α is between 20 degrees and 50 degrees. In a case where the incident angle α is relatively large, the difference between the transmittance Tp of the P-polarized component and the transmittance Ts of the S-polarized component of the medium beam splitter 02 is very large, so, after the circularly polarized light passes through the beam splitter 02, an ellipticity may be greatly reduced, forming stray light and ghosting, which affects a viewing effect.

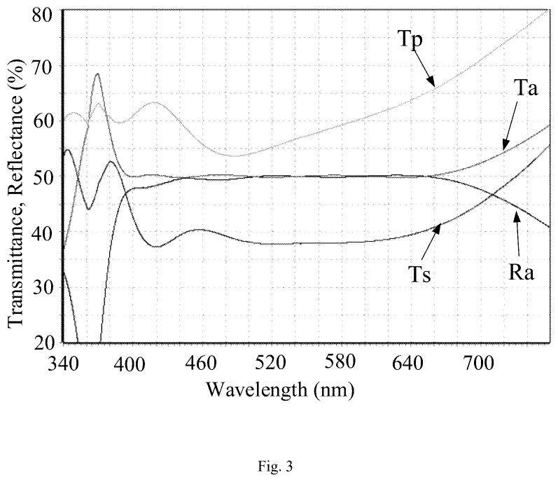

FIG. 3 is a curve chart of reflectances and transmittances of a medium beam splitter for light incident at different incident angles. FIG. 3 shows a reflectance Ra and a transmittance Ta of the medium beam splitter when an incident angle of the incident light is 0 degrees, as well as a transmittance Ts of an S-polarized component and a transmittance Tp of a P-polarized component of the incident light when an incident angle of the incident light is 40 degrees. As illustrated by FIG. 3, when the incident angle is 40 degrees, the transmittance Ts of the S-polarized component and the transmittance Tp of the P-polarized component both deviate from target values (the target values both being 50%); and the difference between the transmittance Ts of the S-polarized component and the transmittance Tp of the P-polarized component is relatively large, and a beam splitting effect of the beam splitter is not ideal.

The embodiments of the present disclosure provide an optical structure and a display device. The optical structure has a light incident side and a light-exiting side; and the optical structure includes a lens structure, a beam splitting film, a light-transmitting protective film, a phase retardation film and a polarizing reflective film. The lens structure includes a first surface and a second surface arranged opposite to each other; the first surface is a surface of the lens structure on the light incident side, and the first surface is a curved surface; the beam splitting film is located on a side of the first surface away from the second surface; the light-transmitting protective film is located on a side of the beam splitting film away from the first surface and in contact with the beam splitting film; the phase retardation film is located on a side of the second surface away from the first surface; and the polarizing reflective film is located on a side of the second surface away from the first surface. The beam splitting film includes a metal layer; the light-transmitting protective film includes a structure layer; a refractive index of the structure layer gradually decreases along a reference direction; and the reference direction is a direction in which the beam splitting film points towards the light-transmitting protective film.

In the optical structure provided by the embodiments of the present disclosure, the beam splitting film includes the metal layer; since reflection and transmission of a metal material is not sensitive to polarization, when an incident angle of light incident to the beam splitting film is relatively large (e.g., when the incident angle is larger than 20 degrees), a difference between a transmittance of a P-polarized component and a transmittance Ts of an S-polarized component of the incident light is not large; as compared with the medium beam splitting film, the beam splitting film provided with the metal layer can improve consistency between the transmittance Tp of the P-polarized component and the transmittance Ts of the S-polarized component of the incident light, which may reduce influence on the ellipticity of the incident light and make the ellipticity of the incident light as close to 1 as possible. It should be noted that the medium beam splitting film according to the present disclosure refers to a beam splitting film without the metal layer.

In this embodiment, a side of the beam splitting film away from the first surface is further provided with a light-transmitting protective film in contact with the beam splitting film; the light-transmitting protective film can protect the metal layer inside the beam splitting film, avoiding corrosion and oxidation of the metal layer inside the beam splitting film. In addition, the light-transmitting protective film includes the structure layer; the refractive index of the structure layer gradually decreases along the reference direction; the structure layer can avoid interference fringes of the incident light on the structural layer, and prevent the light-transmitting protective film from affecting the reflection spectrum and the transmission spectrum of the beam splitting film, so, the light-transmitting protective film can protect the metal layer in the beam splitting film, without affecting a broadband beam splitting characteristic of the beam splitting film.

Hereinafter, the optical structure and the display device provided by the embodiments of the present disclosure will be illustrated in detail in conjunction with the accompanying drawings.

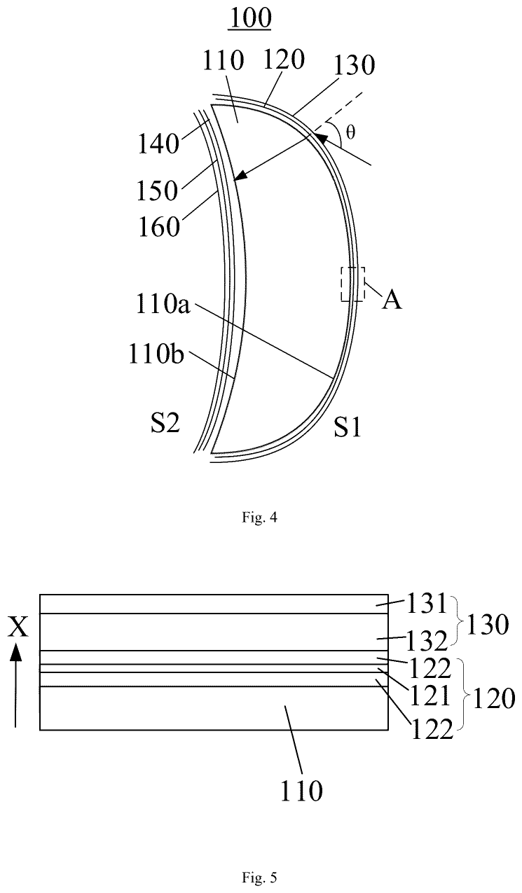

Embodiments of the present disclosure provides an optical structure. FIG. 4 is a cross-sectional schematic diagram of an optical structure provided by an embodiment of the present disclosure; and FIG. 5 is a partially enlarged cross-sectional schematic diagram of an optical structure illustrated by FIG. 4. As illustrated by FIG. 4 and FIG. 5, the optical structure 100 has a light incident side S1 and a light-exiting side S2; the optical structure 100 includes a lens structure 110, a beam splitting film 120, a light-transmitting protective film 130, a phase retardation film 140 and a polarizing reflective film 150. The lens structure 110 includes a first surface 110a and a second surface 110b arranged opposite to each other; the first surface 110a is a surface of the lens structure 110 on the light incident side, and the first surface 110a is a curved surface; the beam splitting film 120 is located on a side of the first surface 110a away from the second surface 110b; the light-transmitting protective film 130 is located on a side of the beam splitting film 120 away from the first surface 110a and is in contact with the beam splitting film 120; the phase retardation film 140 is located on a side of the second surface 110b away from the first surface 110a; and the polarizing reflective film 150 is located on a side of the second surface 110b away from the first surface 110a. The beam splitting film 120 includes a metal layer 121; the light-transmitting protective film 130 includes a structure layer 131; a refractive index of the structure layer 131 gradually decreases along a reference direction X; and the reference direction X is a direction in which the beam splitting film 120 points towards the light-transmitting protective film 130.

In the optical structure 100 provided by the embodiment of the present disclosure, the beam splitting film 120 includes the metal layer 121; since reflection and transmission of a metal material is not sensitive to polarization, when an incident angle θ of incident light incident to the beam splitting film 120 is relatively large, for example, when the incident angle θ is larger than 20 degrees, for example, the incident angle θ is between 20 degrees to 50 degrees, as compared with the medium beam splitting film, the beam splitting film 120 provided with the metal layer 121 can make a transmittance Tp of a P-polarized component and a transmittance Ts of an S-polarized component of the incident light have a relatively small difference, and can improve consistency between the transmittance of the P-polarized component and the transmittance Ts of the S-polarized component of the incident light, which can reduce influence on the ellipticity of the incident light and make the ellipticity of the incident light as close to 1 as possible.

In this embodiment, the side of the beam splitting film 120 away from the first surface 110a is provided with the light-transmitting protective film 130 in contact with the beam splitting film 120; the light-transmitting protective film 130 can protect the metal layer 121 inside the beam splitting film 120, avoiding corrosion and oxidation of the metal layer 121 inside the beam splitting film 120. In addition, the light-transmitting protective film 130 includes the structure layer 131; the refractive index of the structure layer 131 gradually decreases along the reference direction X; the structure layer 131 can prevent avoid interference fringes of the incident light on the structural layer, and prevent the light-transmitting protective film 130 from affecting a reflection spectrum and a transmission spectrum of the beam splitting film 120, so, the light-transmitting protective film 130 can protect the metal layer 121 of the beam splitting film 120, without affecting a broadband beam splitting characteristic of the beam splitting film 120.

It should be noted that the diagram schematically show that the lens structure 110 includes one lens; and the first surface 110a and the second surface 110b of the lens structure 110 are surfaces arranged opposite to each other. However, this will not be limited in the embodiments of the present disclosure, and the lens structure 110 may include a plurality of lenses. For example, when the lens structure 110 includes the plurality of lenses, the plurality of lenses include a plurality of surfaces; and the second surface 110b may be an outer surface close to the light-exiting side among the plurality of surfaces, or a surface which is between two outermost surfaces among the plurality of surfaces. For example, when the lens structure 110 includes the plurality of lenses, the first surface 110a and the second surface 110b may be two outer surfaces of a same lens, or may also be outer surfaces of different lenses. For example, the lens structure 110 may include two, three, or four lenses, etc. For example, the second surface 110b may be a flat surface, or may also be a curved surface. For example, the plurality of lenses of the lens structure 110 may be spaced apart, or may also be attached together. The lens structure 110 will not be limited in the embodiments of the present disclosure. In addition, FIG. 5 schematically shows a partially enlarged cross-sectional schematic diagram of FIG. 4 in position A; it can be understood that structures of the beam splitting film 120 and the light-transmitting protective film 130 located in other positions on the first surface 110a of the lens structure 110 are the same as those in FIG. 5.

In some examples, as illustrated by FIG. 5, the light-transmitting protective film 130 further includes a base layer 132; the base layer 132 is closer to the beam splitting film 120 than the structure layer 131; and the base layer 132 is in contact with the beam splitting film 120 and is configured to protect the beam splitting film 120. The base layer 132 of the light-transmitting protective film 130 can protect the metal layer 121 of the beam splitting film 120, isolate water vapor and oxygen in the air, and avoid corrosion and oxidation of the metal layer 121.

In some examples, as illustrated by FIG. 5, a refractive index of the base layer 132 is not less than a maximum refractive index of the structure layer 131. For example, the refractive index of the base layer 132 may be equal to the maximum refractive index, or may also be greater than the maximum refractive index. For example, the refractive index of the structure layer 131 gradually decreases along the reference direction X; the maximum refractive index of the structure layer 131 may be a refractive index of a material layer having a set thickness on a side of the structure layer 131 close to the base layer 132; the set thickness may be a minimum thickness that can measure a value of the refractive index, or the set thickness may also be 1/20 of a total thickness of the structure layer 131 or less. Of course, the refractive index of the base layer 132 will not be limited in the embodiments of the present disclosure, and the material of the base layer 132 and the corresponding refractive index may be selected according to needs.

In some examples, as illustrated by FIG. 4 and FIG. 5, the reference direction X is a direction in which the beam splitting film 120 points towards the light-transmitting protective film 130. For example, the reference direction X may be an optical axis direction of the lens structure 110. For example, the reference direction X may also be a normal direction of the light-transmitting protective film 130, and at this time, the reference direction X at any position of the light-transmitting protective film 130 is not the same. For example, the reference direction X is related to a fabrication process of the light-transmitting protective film 130. The reference direction X will not be limited in the embodiments of the present disclosure, as long as the reference direction X meets the condition that the beam splitting film 120 points towards the light-transmitting protective film 130.

In some examples, as illustrated by FIG. 4 and FIG. 5, the light-transmitting protective film 130 is located on the outermost surface of the lens structure 110; and a side of the light-transmitting protective film 130 away from the lens structure 110 is in contact with the air.

In some examples, as illustrated by FIG. 4, the light-transmitting protective film 130 covers the beam splitting film 120, so that the beam splitting film 120 can be completely isolated from the air.

In some examples, as illustrated by FIG. 5, the beam splitting film 120 includes the metal layer 121 and at least one non-metal layer 122 stacked with the metal layer 121. FIG. 5 schematically shows that the beam splitting film 120 includes the metal layer 121 and a plurality of non-metal layers 122; and the plurality of non-metal layers 122 are respectively located on two sides of the metal layer 121. A number of non-metal layers 122 and positions in which they are stacked with the metal layer 121 will not be limited in the embodiments of the present disclosure.

For example, a material of the metal layer 121 may be silver, aluminum, gold, chromium, molybdenum, indium, silver-gold alloy, silver-indium alloy, indium-zinc alloy, etc. For example, a thickness of the metal layer 121 ranges from 1 nm to 50 nm; for example, the thickness of the metal layer 121 may be 5 nm, 10 nm, 20 nm, 30 nm, 40 nm, etc., which will not be listed one by one here. The material and the thickness of the metal layer 121 will not be limited in the embodiments of the present disclosure.

For example, a material of the non-metal layer 122 may be silicon dioxide (SiO₂), titanium dioxide (TiO₂), niobium pentoxide (Nb₂O₅), tantalum pentoxide (Ta₂O₅), aluminum oxide (Al₂O₃), zirconium dioxide (ZrO₂), cerium dioxide (CeO₂), hafnium disulfide (HfO₂), silicon nitride (Si₃N₄), zinc sulfide (ZnS), etc. For example, a thickness of the non-metal layer 122 ranges from 1 nm to 250 nm, for example, the thickness of the non-metal layer 122 may be 5 nm, 50 nm, 100 nm, 150 nm, 200 nm, etc., which will not be listed one by one here. The number of non-metal layers 122, as well as the material and the thickness thereof will not be limited in the embodiments of the present disclosure.

In some examples, a transmittance and a reflectance of the beam splitting film 120 with respect to visible light are respectively 20% to 80%, and an absorptance of the beam splitting film 120 for the visible light absorption rate is not more than 25%. For example, the transmittance and the reflectance of the beam splitting film 120 are respectively 50% and 50%, or the transmittance and the reflectance of the beam splitting film 120 are respectively 40% and 60%, which will not be described in detail here.

In some examples, as illustrated by FIG. 4, the polarizing reflective film 150 of the optical structure 100 is located on a side of the phase retardation film 140 away from the first surface 110a, however, this will not be limited in the embodiments of the present disclosure.

In some examples, as illustrated by FIG. 4, the optical structure 100 further includes a polarized absorption film 160; and the polarized absorption film 160 is located on a side of the polarizing reflective film 150 away from the first surface 110a.

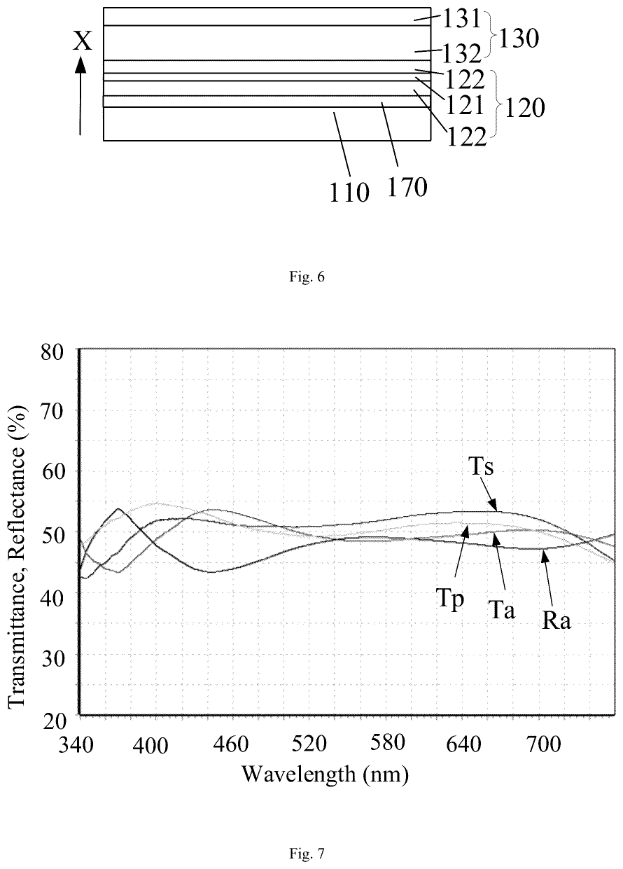

In some examples, as illustrated by FIG. 5, the beam splitting film 120 may be in contact with the lens; and the beam splitting film 120 is directly attached onto the lens structure 110. However, this will not be limited in the embodiments of the present disclosure. FIG. 6 is another partially enlarged cross-sectional schematic diagram of an optical structure illustrated by FIG. 4. As illustrated by FIG. 6, the optical structure 100 may further include a bonding film 170; the bonding film 170 is located between the beam splitting film 120 and the lens structure 110; and the bonding film 170 is configured to bond the beam splitting film 120 onto the lens structure 110. A material and a thickness of the bonding film 170 will not be limited in the embodiments of the present disclosure.

FIG. 7 is a curve chart of reflectances and transmittances of a beam splitting film provided by an embodiment of the present disclosure for light incident at different incident angles. FIG. 7 shows a reflectance Ra and a transmittance Ta when an incident angle of the incident light is 0 degrees, as well as a transmittance Ts of an S-polarized component and a transmittance Tp of a P-polarized component of the incident light when an incident angle of the incident light is 40 degrees, with respect to the beam splitter film provided by the embodiment of the present disclosure. As illustrated by FIG. 7, when the incident angle is 40 degrees, the transmittance Ts of the S-polarized component and the transmittance Tp of the P-polarized component of the incident light are both substantially equal to target values (the target values both being 50%), and a difference between the transmittance Ts of the S-polarized component and the transmittance Tp of the P-polarized component is relatively small. As illustrated by FIG. 3, when the incident angle is 40 degrees, the difference between the transmittance Ts of the S-polarized component and the transmittance Tp of the P-polarized component of the incident light with respect to the beam splitting film provided with the metal layer is much less than the difference between the transmittance Ts of the S-polarized component and the transmittance Tp of the P-polarized component with respect to the medium beam splitting film. Therefore, by providing the metal layer inside the beam splitting film, consistency between the transmittance Tp of the P-polarized component and the transmittance Ts of the S-polarized component of the incident light may be improved, which reduces influence on the ellipticity of the incident light and makes the ellipticity of the incident light as close to 1 as possible.

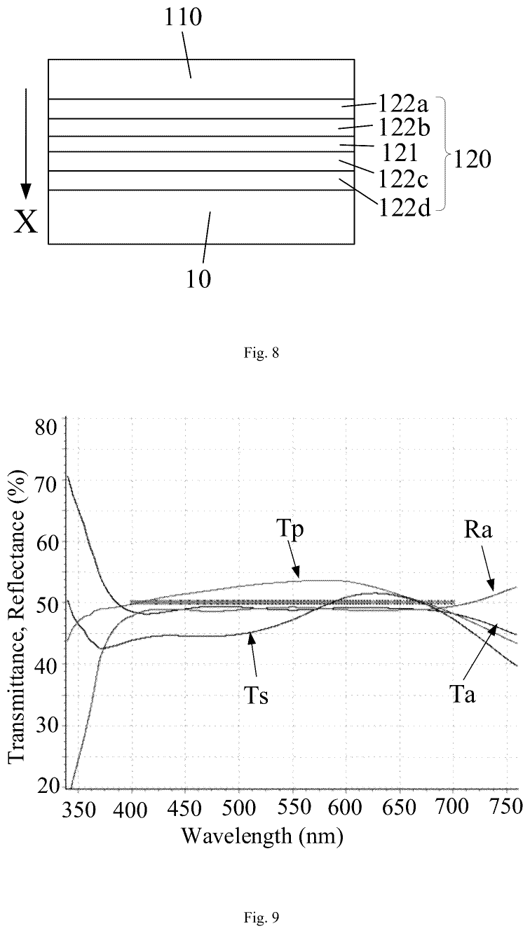

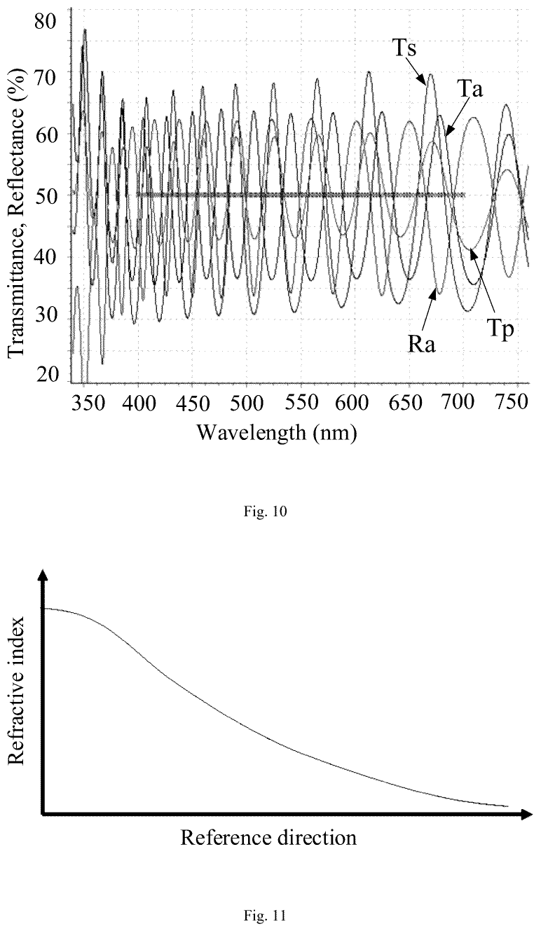

FIG. 8 is a partially enlarged cross-sectional schematic diagram of a beam splitting film provided by an embodiment of the present disclosure after coating with a protective layer; FIG. 9 is a curve chart of reflectances and transmittances of a beam splitting film and a protective layer illustrated by FIG. 8 for light incident at different incident angles; and FIG. 10 is another curve chart of reflectances and transmittances of a beam splitting film and a protective layer illustrated by FIG. 8 for light incident at different incident angles.

As illustrated by FIG. 8, the beam splitting film 120 includes the metal layer 121 and the plurality of non-metal layers 122; the material of the metal layer 121 is silver (Ag) with the thickness of 19.9 nm; the materials of the non-metal layer 122a and the non-metal layer 122b arranged at the side of the metal layer 121 t close to the lens structure 110 are aluminum oxide (Al₂O₃) and titanium dioxide (TiO₂) respectively, and the thicknesses thereof are 215.3 nm and 63.6 nm respectively; and the materials of the non-metal layer 122c and the non-metal layer 122d arranged at the side of the metal layer 121 away from the lens structure 110 are aluminum oxide (Al₂O₃) and silicon dioxide (SiO₂) respectively, the thicknesses thereof are 79.1 nm and 286.1 nm respectively. In order to protect the metal layer 121 of the beam splitting film 120 from corrosion and oxidation, a protective layer 10 may be re-coated or plated on the surface of the beam splitting film 120. For example, an acrylic coating with a thickness of 2 μm may be applied by using a wet method, or a Parylene C barrier layer with a thickness of 200 nm may be plated by using a chemical vapor deposition (CVD) method. The diagram shows that the protective layer 10 is an acrylic coating.

FIG. 9 shows, in a case where the incident light does not pass through the air, but instead is directly incident to the beam splitting film 120 from the protective layer 10 and enters the lens structure 110, a reflectance Ra and a transmittance Ta for the incident light when the incident angle of the incident light is 0 degrees, as well as a transmittance Ts of the S-polarized component and a transmittance Tp of the P-polarized component of the incident light when the incident angle of the incident light is 40 degrees, as illustrated by FIG. 9, when the incident angle of the incident light is 0 degrees, the reflectance Ra and the transmittance Ta for the incident light are both substantially equal to the target values (the target values both being 50%); when the incident angle of the incident light is 40 degrees, the transmittance Ts of the S-polarized component and the transmittance Tp of the P-polarized component of the incident light are both substantially equal to the target values (the target values both being 50%); and the beam splitting film 120 has an ideal beam splitting effect.

However, the protective layer 10 with the thickness ranging from hundreds of nanometers to several micrometers is formed on the surface of the beam splitting film 120; the thickness of the protective layer 10 is always limited and on the order of micrometers; and there is always an interface between the protective layer 10 and the air. Due to interference of light on the upper and lower surfaces of the protective layer 10, the reflection spectrum and the transmission spectrum of the beam splitting film 120 can superimpose interference fringes, causing the beam splitting film 120 to no longer meet the broadband splitting characteristics it is expected to have.

FIG. 10 shows, in a case where the incident light is incident to the protective layer 10 and the beam splitting film 120, and further enters the lens structure 110 from the air, a reflectance Ra and a transmittance Ta when the incident angle of the incident light is 0 degrees, as well as a transmittance Ts of the S-polarized component and a transmittance Tp of the P-polarized component when the incident angle of the incident light is 40 degrees. As illustrated by FIG. 10, when the incident angle of the incident light is 0 degrees, the reflectance Ra and the transmittance Ta of the incident light both deviate from the target values (the target values both being 50%); when the incident angle of the incident light is 40 degrees, the transmittance Ts of the S-polarized component and the transmittance Tp of the P-polarized component both deviate from the target values (the target values both being 50%); and the beam splitting film 120 has lost its beam splitting function.

Therefore, directly providing the protective layer 10 with a constant refractive index on the surface of the beam splitting film 120 can destroy the beam splitting effect of the beam splitting film 120. However, by providing the structure layer 131 whose refractive index gradually decreases along the reference direction X on the surface of the beam splitting film 120, the structural layer 131 can avoid interference fringes of the incident light on the structural layer 131, and prevent the light-transmitting protective film 130 from causing adverse effects on the reflection spectrum and the transmission spectrum of the beam splitting film 120. Therefore, the light-transmitting protective film 130 can protect the metal layer 121 of the beam splitting film 120, without affecting the broadband beam splitting characteristic of the beam splitting film 120.

FIG. 11 is a schematic diagram of one type of refractive index variation of a structure layer of a light-transmitting protective film provided by an embodiment of the present disclosure. As illustrated by FIG. 11, the refractive index of the structure layer of the light-transmitting protective film may continuously decrease along the reference direction. A left end of a horizontal axis is a side of the structure layer close to the beam splitting film; a right end of the horizontal axis is a side of the structure layer away from the beam splitting film; and the refractive index of the structure layer may continuously decrease along the reference direction. A trend of continuous decrease will not be specifically limited in the embodiments of the present disclosure. For example, the trend of continuous decrease may be a straight line presenting linear variation, a curve presenting exponential variation, or other forms of variation trend; for example, the curve presenting exponential variation, may be square, cubic or quantic and so on.

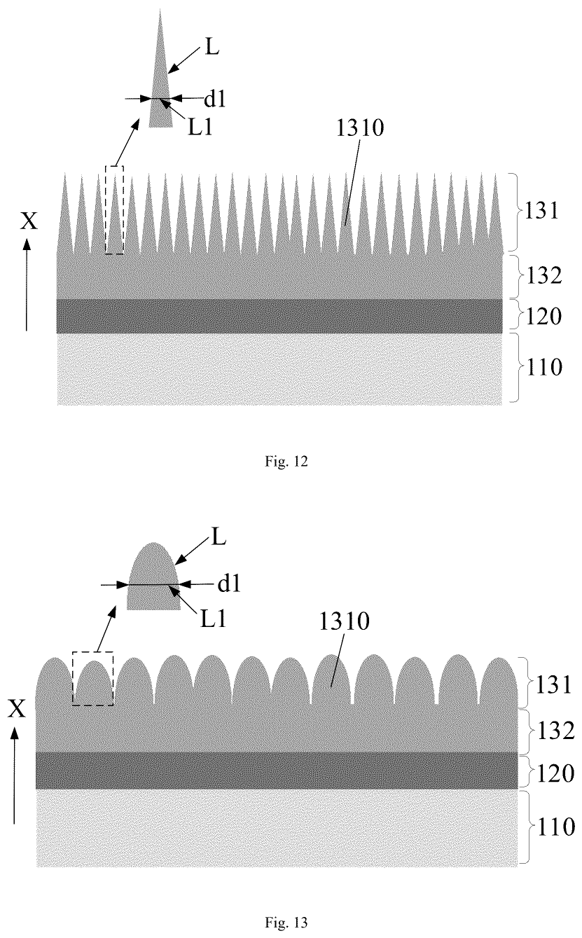

FIG. 12 is another partially enlarged cross-sectional schematic diagram of a light-transmitting protective film provided by an embodiment of the present disclosure. As illustrated by FIG. 12, the structure layer 131 of the light-transmitting protective film 130 includes a plurality of protruding structures 1310; along the reference direction X, dimensions d1 of cross-sectional line segments L1 of a longitudinal section of each of the plurality of protruding structures 1310 gradually decreases, and a direction of each of the cross-sectional line segments L1 is perpendicular to the reference direction X, the longitudinal section is parallel to the reference direction X. The figure schematically shows that the longitudinal section of the protruding structure 1310 is triangular, and schematically shows one cross-sectional line segment L1, two ends of the cross-sectional line segment L1 are defined by the outer contour of the convex structure 1310. By providing the protruding structure 1310 and making the cross-sectional dimension d1 of the protruding structure 1310 gradually decrease, the refractive index of the structure layer 131 can be made continuously decrease along the reference direction X. For example, the plurality of protruding structures may be evenly distributed, and a height ratio of different protruding structures ranges from 0.8 to 1.2.

In some examples, as illustrated by FIG. 12, along the reference direction X, an area of the cross section of the protruding structure 1310 continuously decreases; and the cross section of the protruding structure 1310 is perpendicular to the reference direction X.

In some examples, as illustrated by FIG. 12, a lateral side L of a longitudinal section of the protruding structure 1310 includes a straight line segment, and the longitudinal section is parallel to the reference direction X. For example, a slope of the straight line segment may be designed according to requirements or fabrication processes of the light-transmitting protective film 130. An outer contour of the protruding structure 1310 will not be limited in the embodiments of the present disclosure, and may be designed according to requirements and fabrication processes.

For example, as illustrated by FIG. 12, a shape of the protruding structure 1310 may be a conical shape; and a shape of the longitudinal section of the conical shape may be a triangular shape.

FIG. 13 is another partially enlarged cross-sectional schematic diagram of a light-transmitting protective film provided by an embodiment of the present disclosure. As illustrated by FIG. 13, the structure layer 131 of the light-transmitting protective film 130 includes the plurality of protruding structures 1310; along the reference direction X, dimensions d1 of cross-sectional line segments L1 of a longitudinal section of each of the plurality of protruding structures 1310 gradually decreases, and a direction of each of the cross-sectional line segments L1 is perpendicular to the reference direction X, the longitudinal section is parallel to the reference direction X. The figure schematically shows that the longitudinal section of the protruding structure 1310 is semi-elliptical, and schematically shows one cross-sectional line segment L1, two ends of the cross-sectional line segment L1 are defined by the outer contour of the convex structure 1310. By providing the protruding structure 1310 and making the cross-sectional dimension d1 of the protruding structure 1310 gradually decrease, the refractive index of the structure layer 131 can be made continuously decrease along the reference direction X.

In some examples, as illustrated by FIG. 13, the lateral side L of the longitudinal section of the protruding structure 1310 includes a curved line segment; and the longitudinal section is parallel to the reference direction X. For example, a shape of the protruding structure 1310 may be a shape similar to a warhead.

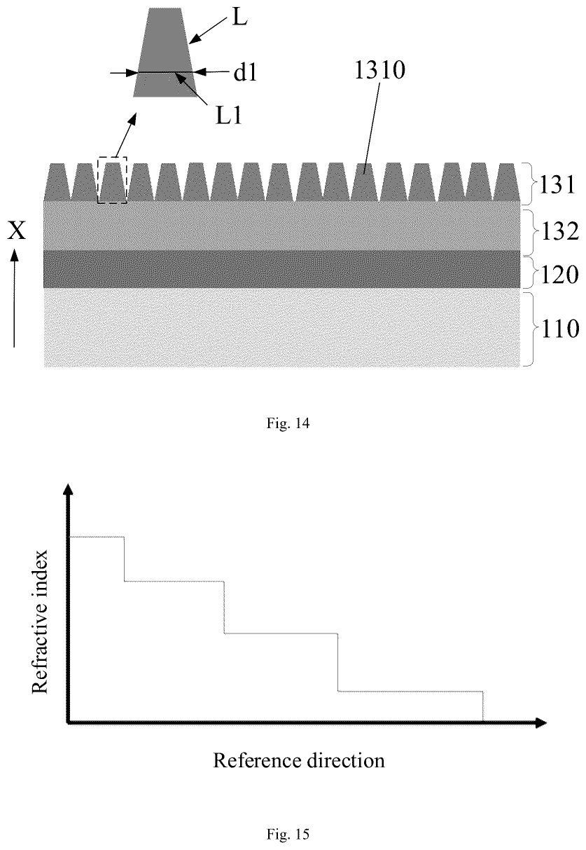

FIG. 14 is another partially enlarged cross-sectional schematic diagram of a light-transmitting protective film provided by an embodiment of the present disclosure. As illustrated by FIG. 14, the structure layer 131 of the light-transmitting protective film 130 includes the plurality of protruding structures 1310; along the reference direction X, dimensions d1 of cross-sectional line segments L1 of a longitudinal section of each of the plurality of protruding structures 1310 gradually decreases, and a direction of each of the cross-sectional line segments L1 is perpendicular to the reference direction X, the longitudinal section is parallel to the reference direction X. The figure schematically shows that the longitudinal section of the protruding structure 1310 is trapezoidal, and schematically shows one cross-sectional line segment L1, two ends of the cross-sectional line segment L1 are defined by the outer contour of the convex structure 1310. For example, a shape of the protruding structure 1310 may be in a shape of a circular truncated cone; and a shape of a longitudinal section of the circular truncated cone may be in a shape of trapezoid.

In some examples, as illustrated by FIG. 12 to FIG. 14, a maximum height H of the protruding structure 1310 in the reference direction X ranges from 50 nm to 200 nm; and the maximum height H of the protruding structure 1310 in the reference direction X is also a maximum thickness of the protruding structure 1310 in the reference direction X. A value of the maximum height H will not be limited in the embodiments of the present disclosure, and may be designed according to requirements and fabrication processes of the light-transmitting protective film 130. For example, the value of the maximum height H may be 80 nm, 100 nm, 130 nm, 150 nm, 180 nm, etc., which will not be listed one by one here.

FIG. 12 to FIG. 14 schematically show that heights of the protruding structures 1310 in the reference direction X are equal to each other; however, this will not be limited in the embodiments of the present disclosure, and the heights of the protruding structures 1310 in the reference direction X in different positions may also be different from each other, which may be specifically designed according to requirements and fabrication processes of the light-transmitting protective film 130.

In some examples, as illustrated by FIG. 12 to FIG. 14, the cross-sectional dimension d1 of the protruding structure 1310 gradually decreases along the reference direction X, and the cross-sectional dimension d1 of the protruding structure 1310 has a maximum value. The maximum value of the cross-sectional dimension d1 of the protruding structure 1310 ranges from 10 nm to 200 nm. The maximum value of the cross-sectional dimension d1 will not be limited in the embodiments of the present disclosure, and may be designed according to requirements and fabrication processes of the light-transmitting protective film 130. For example, the maximum value of the cross-sectional dimension d1 may be 20 nm, 50 nm, 80 nm, 100 nm, 130 nm, 150 nm, 180 nm, etc., which will not be listed one by one here.

In some examples, as illustrated by FIG. 12 to FIG. 14, along the reference direction X, a spacing distance between two adjacent protruding structures 1310 gradually increases; and two adjacent protruding structures 1310 has a minimum spacing distance. FIG. 12 to FIG. 14 schematically show that the minimum spacing distance between two adjacent protruding structures 1310 is 0; however, this will not be limited in the embodiments of the present disclosure, and a value of the minimum spacing distance between two adjacent protruding structures 1310 ranges from 0 nm to 200 nm, which may be designed according to requirements and fabrication processes of the light-transmitting protective film 130. For example, the numerical values of the minimum spacing distance d2 may be 10 nm, 50 nm, 100 nm, 130 nm, 150 nm, 180 nm, etc., which will not be listed one by one here.

In some examples, FIG. 12 and FIG. 13 schematically show that the materials of the base layer 132 and the structure layer 131 of the light-transmitting protective film 130 are the same. For example, the base layer 132 and the structure layer 131 may be an integrated structure. FIG. 14 schematically shows that the materials of the base layer 132 and the structure layer 131 of the light-transmitting protective film 130 are different. This will not be limited in the embodiments of the present disclosure, and the base layer 132 and the structure layer 131 may be made of the same material, or may also be made of different materials.

For example, the plurality of protruding structures 1310 are arranged in an array within a plane where the light-transmitting protective film 130 is located.

In some examples, as illustrated by FIG. 12 and FIG. 13, when the materials of the base layer 132 and the structure layer 131 of the light-transmitting protective film 130 are the same, the material for forming the base layer 132 and the structure layer 131 may be deposited firstly, and then the plurality of protruding structures 1310 may be directly formed on a surface of the deposited material. For example, the plurality of protruding structures 1310 may be formed by using chemical etching, plasma etching, or nanoimprint techniques, etc.

In some examples, as illustrated by FIG. 14, when the materials of the base layer 132 and the structure layer 131 of the light-transmitting protective film 130 are different, one material may be used to form the base layer 132, then a second material is further coated on a surface of the base layer 132, and next, the plurality of protruding structures 1310 are directly formed on a surface of the second material. For example, the plurality of protruding structures 1310 may be formed by using chemical etching, plasma etching, or nanoimprint techniques, etc.

FIG. 15 is a schematic diagram of another type of refractive index variation of a structure layer of a light-transmitting protective film provided by an embodiment of the present disclosure. As illustrated by FIG. 15, the refractive index of the structure layer of the light-transmitting protective film may decrease step by step along the reference direction X; and the diagram shows that the structure layer of the light-transmitting protective film has four decreasing steps. A number of the decreasing steps of the refractive index of the structure layer of the light-transmitting protective film will not be specifically limited, and the difference between decreasing steps will not be specifically limited in the embodiments of the present disclosure. For example, the number of decreasing steps of the refractive index of the structure layer is greater than or equal to 3.

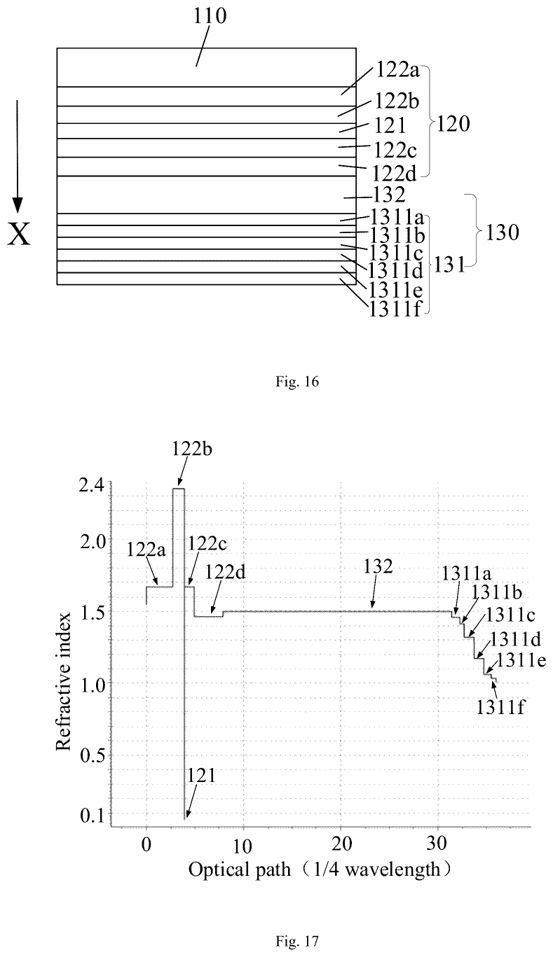

FIG. 16 is another partially enlarged cross-sectional schematic diagram of a beam splitting film and a light-transmitting protective film of an optical structure provided by an embodiment of the present disclosure. As illustrated by FIG. 16, the structure layer 131 includes at least three structure sub-layers 1311; the at least three structure sub-layers 1311 are sequentially arranged along the reference direction X and refractive indices of the at least three structure sub-layers 1311 sequentially decrease along the reference direction X. The diagram schematically shows that the structure layer 131 includes six structure sub-layers 1311; the six structure sub-layers 1311 are sequentially arranged along the reference direction X, and refractive indices of the six structure sub-layers 1311 sequentially decrease along the reference direction X; and of course, a number of the structure sub-layers 1311 included in the structure layer 131 will not be limited in the embodiments of the present disclosure.

In some examples, as illustrated by FIG. 16, material densities of the six structure sub-layers 1311 sequentially decrease along the reference direction X. The material density of the structure sub-layer 1311 is a proportion of material per unit volume; and the material density of the structure sub-layer 1311 is positively correlated with the refractive index. The higher the density, the higher the refractive index, and the lower the density, the lower the refractive index. By making the material densities of the plurality of structure sub-layers 1311 sequentially decrease along the reference direction X, the refractive indices of the plurality of structure sub-layers 1311 sequentially decrease along the reference direction X.

For example, as illustrated by FIG. 16, the materials of the six structure sub-layers 1311 may be the same; and refractive index variation may be implemented by changing the material density. For example, the materials of the six structure sub-layers 1311 and the base layer 132 may be the same. Of course, this will not be limited in the embodiments of the present disclosure; the materials of the plurality of structure sub-layers 1311 may also be different, and refractive index variation of the plurality of structure sub-layers 1311 may be implemented through different refractive indices of different materials.

For example, as illustrated by FIG. 16, the base layer 132 may be formed firstly, and then refractive indices of layers deposited subsequently may be made sequentially decrease by changing deposition conditions, thereby forming the plurality of structure sub-layers 1311 whose refractive indices sequentially decrease along the reference direction X. For example, the layer deposited may be made to have pores by changing deposition conditions; different deposition conditions result in different densities of pores or different numbers of pores, thereby material densities of the structure sub-layers 1311 may be changed to implement refractive index variation of the plurality of structure sub-layers 1311.

For example, the embodiment of the present disclosure is not limited thereto, and materials with different refractive indices may also be respectively deposited to form the plurality of structure sub-layers whose refractive indices sequentially decrease along the reference direction X.

For example, as illustrated by FIG. 16, the beam splitting film 120 includes the metal layer 121 and the plurality of non-metal layers 122. The material of the metal layer 121 is silver (Ag) with the thickness of 19.8 nm; the materials of the non-metal layers 122a, 122b, 122c and 122d are respectively aluminum oxide (Al₂O₃), titanium dioxide (TiO₂), aluminum oxide (Al₂O₃) and silicon dioxide (SiO₂), respectively with thicknesses of 208.5 nm, 63.9 nm, 79.8 nm, and 260.8 nm.

For example, as illustrated by FIG. 16, the base layer 132 of the light-transmitting protective film 130 is the acrylic coating with the thickness of 2,000 nm; the six structure sub-layers 1311a, 1311b, 1311c, 1311d, 1311e and 1311f are respectively acrylic coatings with densities of 90%, 80%, 60%, 30%, 10% and 5%, and respectively with thicknesses of 74.8 nm, 38.4 nm, 96.9 nm, 114.6 nm, 88.7 nm, and 70.8 nm; and the base layer 132 is the acrylic coating with the density of 100%. For example, the thickness of the base layer 132 is greater than the thickness of at least one structure sub-layer 1311.

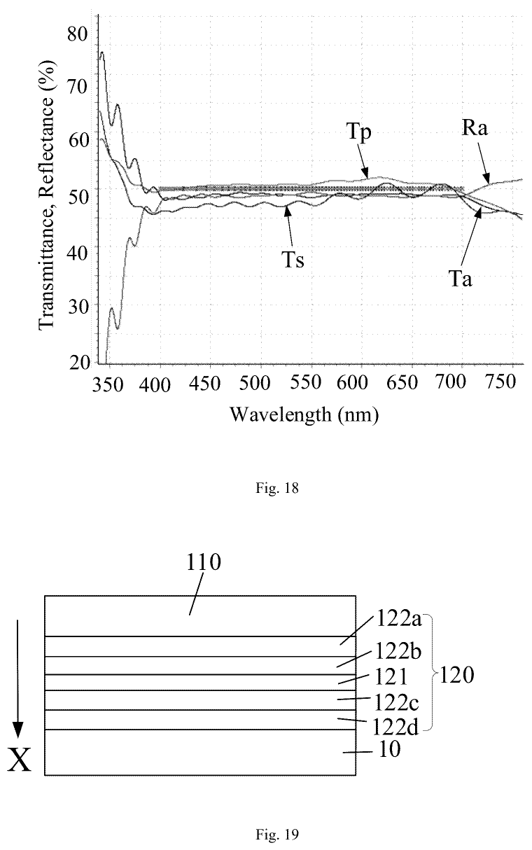

FIG. 17 is a schematic diagram of reflectances of a beam splitting film and a light-transmitting protective film illustrated by FIG. 16; and FIG. 18 is a curve chart of refractive indices and transmittances of a beam splitting film and a light-transmitting protective film illustrated by FIG. 16 for light incident at different incident angles. FIG. 18 shows a reflectance Ra and a transmittance Ta for incident light when an incident angle of the incident light is 0 degrees, as well as a transmittance Ts of an S-polarized component and a transmittance Tp of a P-polarized component of the incident light when an incident angle of the incident light is 40 degrees, with respect to the beam splitting film and the light-transmitting protective film of FIG. 16. As illustrated by FIG. 17, the refractive indices of the six structure sub-layers 1311 of the optical structure sequentially decrease. As illustrated by FIG. 18, when the incident angle of the incident light is 0 degrees, the reflectance Ra and the transmittance Ta for the incident light are substantially equal to the target values (the target values both being 50%); when the incident angle θ of the incident light is 40 degrees, the transmittance Ts of the S-polarized component and the transmittance Tp of the P-polarized component of the incident light are substantially equal to the target values (the target values both being 50%); and the beam splitting film 120 has an ideal beam splitting effect.

In this example, the side of the beam splitting film 120 away from the lens structure 110 is provided with the light-transmitting protective film 130; the structure layer 131 of the light-transmitting protective film 130 includes the plurality of structure sub-layers 1311; refractive indices or densities of the plurality of structure sub-layers 1311 sequentially decrease along the reference direction X; the structure layer 131 may avoid interference fringes of the incident light on the structural layer 131, and prevent the light-transmitting protective film 130 from causing adverse effects on the reflection spectrum and the transmission spectrum of the beam splitting film 120. Therefore, the light-transmitting protective film 130 can protect the metal layer 121 of the beam splitting film 120, without affecting the broadband beam splitting characteristic of the beam splitting film 120.

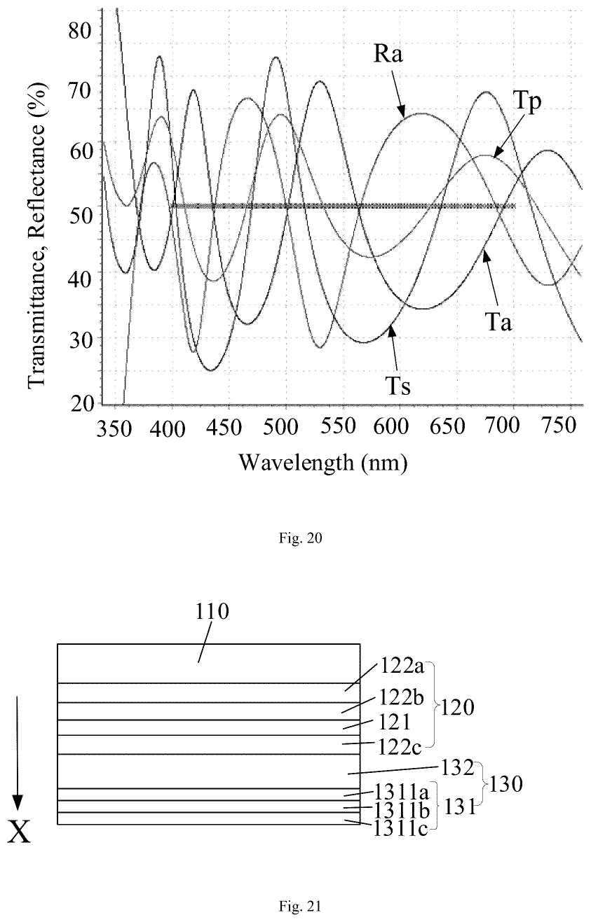

FIG. 19 is a partially enlarged cross-sectional schematic diagram of a beam splitting film provided by an embodiment of the present disclosure after coating with a protective layer; and FIG. 20 is a curve chart of reflectances and transmittances of a beam splitting film and a protective layer illustrated by FIG. 19 for light incident at different incident angles. FIG. 20 shows a reflectance Ra and a transmittance Ta for incident light when an incident angle of the incident light is 0 degrees, as well as a transmittance Ts of an S-polarized component and a transmittance Tp of a P-polarized component when an incident angle of the incident light is 40 degrees, with respect to the beam splitting film and the protective layer of FIG. 19. As illustrated by FIG. 19, the beam splitting film 120 of the optical structure includes the metal layer 121 and the plurality of non-metal layers 122. The material of the metal layer 121 is silver (Ag) with the thickness of 19.3 nm, the materials of the non-metal layers 122a, 122b and 122c are aluminum oxide (Al₂O₃), titanium dioxide (TiO₂), and aluminum oxide (Al₂O₃) with thicknesses of 161.2 nm, 61.0 nm, and 53.1 nm, respectively. The surface of the beam splitting film 120 of the optical structure is further coated with the protective layer 10; the material of the protective layer 10 is Parylene C with the thickness of 500 nm. FIG. 20 is a curve chart when the incident light is incident to the protective layer 10 and the beam splitting film 120, and further enters the lens structure 110 from the air. As illustrated by FIG. 20, when the incident angle of the incident light is 0 degrees, the reflectance Ra and the transmittance Ta for the incident light both deviate from the target values (the target values both being 50%); when the incident angle θ of the incident light is 40 degrees, the transmittance Ts of the S-polarized component and the transmittance Tp of the P-polarized component of the incident light both deviate from the target values (the target values both being 50%); and the beam splitting film 120 has lost its beam splitting function. Therefore, directly coating the protective layer 10 with the constant refractive index on the surface of the beam splitting film 120 can destroy the beam splitting effect of the beam splitting film 120.

FIG. 21 is another partially enlarged cross-sectional schematic diagram of a beam splitting film and a light-transmitting protective film of an optical structure provided by an embodiment of the present disclosure. As illustrated by FIG. 21, the structure layer 131 includes three structure sub-layers 1311; the three structure sub-layers 1311 are sequentially arranged along the reference direction X, and refractive indices of the three structure sub-layers 1311 sequentially decrease along the reference direction X.

In some examples, as illustrated by FIG. 21, material densities of the three structure sub-layers 1311 sequentially decrease along the reference direction X.

For example, as illustrated by FIG. 21, the beam splitting film 120 includes the metal layer 121 and the plurality of non-metal layers 122. The material of the metal layer 121 is silver (Ag) with the thickness of 19.3 nm, and the materials of the non-metal layers 122a, 122b and 122c are aluminum oxide (Al₂O₃), titanium dioxide (TiO₂), and aluminum oxide (Al₂O₃) with thicknesses of 161.2 nm, 61.0 nm, and 53.1 nm, respectively.

For example, as illustrated by FIG. 21, the material of the base layer 132 of the light-transmitting protective film 130 is Parylene C, with the thickness of 300 nm; the materials of the three structure sub-layers 1311a, 1311b and 1311c are Parylene C respectively with densities of 90%, 40% and 10%, and respectively with thicknesses of 102.2 nm, 103.2 nm, and 90.7 nm; and the base layer 132 is also made of Parylene C with the density of 100%. Parylene C is a commonly used polymer waterproof barrier film, which may form a transparent thin film and has a low water vapor permeability.

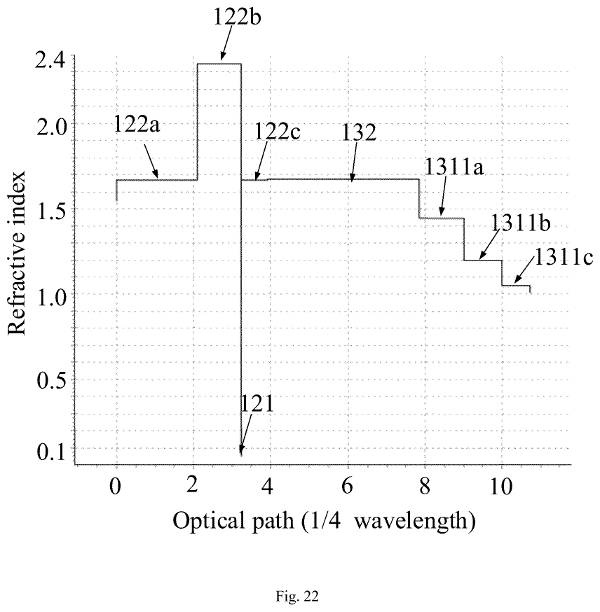

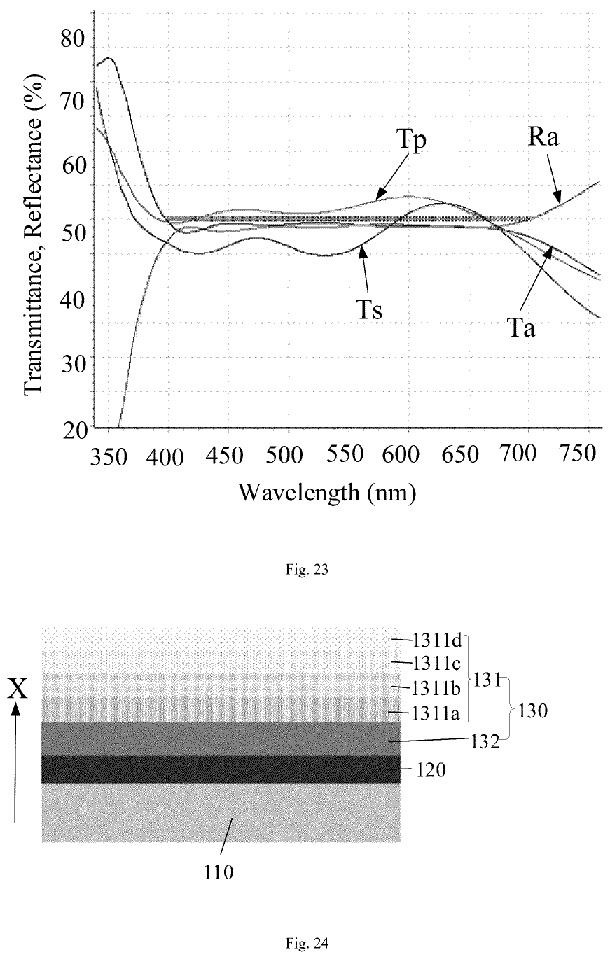

FIG. 22 is a schematic diagram of refractive indices of a beam splitting film and a light-transmitting protective film illustrated by FIG. 21; and FIG. 23 is a curve chart of reflectances and transmittances of a beam splitting film and a light-transmitting protective film illustrated by FIG. 21 for light incident at different incident angles. FIG. 23 shows a reflectance Ra and a transmittance Ta for incident light when an incident angle of the incident light is 0 degrees, as well as a transmittance Ts of an S-polarized component and a transmittance Tp of a P-polarized component of the incident light when an incident angle of the incident light is 40 degrees, with respect to the beam splitting film and the light-transmitting protective film illustrated by FIG. 21. As illustrated by FIG. 22, refractive indices of the three structure sub-layers 1311 of the optical structure 100 sequentially decrease. As illustrated by FIG. 23, when the incident angle of the incident light is 0 degrees, the reflectance Ra and the transmittance Ta for the incident light are both located in the vicinity of the target values (the target values both being 50%); when the incident angle of the incident light is 40 degrees, the transmittance Ts of the S-polarized component and the transmittance Tp of the P-polarized component of the incident light are both located in the vicinity of the target values (the target values both being 50%); and the beam splitting film 120 has an ideal beam splitting effect.

FIG. 24 is another partially enlarged cross-sectional schematic diagram of a beam splitting film and a light-transmitting protective film of an optical structure provided by an embodiment of the present disclosure. As illustrated by FIG. 24, the structure sub-layer 1311 includes a nanoparticle coating; and porosities of the at least three structure sub-layers 1311 sequentially increase along the reference direction X. The porosity of the nanoparticle coating is a proportion of pores between nanoparticles per unit volume; the porosity of the nanoparticle coating is negatively correlated with the refractive index; the higher the porosity, the lower the refractive index; and the lower the porosity, the higher the refractive index. By making the porosities of the plurality of structure sub-layers 1311 sequentially increase along the reference direction X, the refractive indices of the plurality of structure sub-layers 1311 can be made sequentially decrease along the reference direction X.

In the example, the diagram schematically shows that the structure layer 131 includes four structure sub-layers 1311a, 1311b, 1311c and 1311d; the four structure sub-layers 1311a, 1311b, 1311c and 1311d are all nanoparticle coatings; and the porosities of the four nanoparticle coatings 1311a, 1311b, 1311c and 1311d sequentially increase along the reference direction X. Of course, a number of nanoparticle coatings included in the structure layer 131 will not be limited in the embodiments of the present disclosure.

In some examples, as illustrated by FIG. 24, the base layer 132 and the nanoparticle coating may be made of the same material, or may also be made of different the materials, which will not be limited here.

In some examples, the material of the base layer of the light-transmitting protective film includes acrylic, polyurethane, epoxy, amino resin, polyester resin, organosilicon, etc. For example, the base layer may be formed by using solution coating, chemical bath deposition (CBD) or a sol-gel method. For example, the material of the base layer may also be parylene and derivatives thereof, plasma-polymerized hexamethyldisiloxane (ppHMDSO), polytetrafluoroethylene (PTFE), polyvinylidene fluoride (PVDF), etc. For example, the base layer may be formed by using a method such as chemical vapor deposition (CVD), physical vapor deposition (PVD), plasma polymerization (PP), molecular layer deposition (MLD), atomic layer deposition (ALD), etc. The materials and the formation processes of the base layer will not be limited in the embodiments of the present disclosure.

In some examples, the material of the structure layer of the light-transmitting protective film includes at least one selected from the group consisting of acrylic acid, polyurethane, epoxy, amino resin, polyester resin, organosilicon, parylene and derivatives thereof, plasma-polymerized hexamethyldisiloxane, polytetrafluoroethylene, and polyvinylidene fluoride.

For example, the materials of the base layer and the structure layer may be the same, or may also be different.

In some examples, the thickness of the base layer ranges from 100 nm to 5 μm. The thickness of the base layer will not be limited in the embodiments of the present disclosure, and may be designed according to requirements and fabrication processes of the light-transmitting protective film. For example, the thickness of the base layer may be 200 nm, 600 nm, 800 nm, 1 μm, 2 μm, 3 μm, 4 μm, etc., which will not be listed one by one here.

In some examples, the thickness of the structure layer ranges from 50 nm to 200 nm. The thickness of the structure layer will not be limited in the embodiments of the present disclosure, and may be designed according to requirements and fabrication processes of the light-transmitting protective film. For example, the thickness of the structure layer may be 60 nm, 80 nm, 100 nm, 150 nm, etc., which will not be listed one by one here.

In some examples, a total thickness of the light-transmitting protective film ranges from 100 nm to 10 μm. The total thickness of the light-transmitting protective film will not be limited in the embodiments of the present disclosure, and may be designed according to requirements and fabrication processes of the light-transmitting protective film. For example, the total thickness of the light-transmitting protective film may be 200 nm, 600 nm, 800 nm, 1 μm, 3 μm, 5 μm, 8 μm, etc., which will not be listed one by one here. The structure layer whose refractive index decreases in the light-transmitting protective film may avoid interference fringes of the incident light on the structural layer, so that the light-transmitting protective film with a micron or sub-micron thickness can not affect the broadband beam splitting characteristic of the beam splitting film.

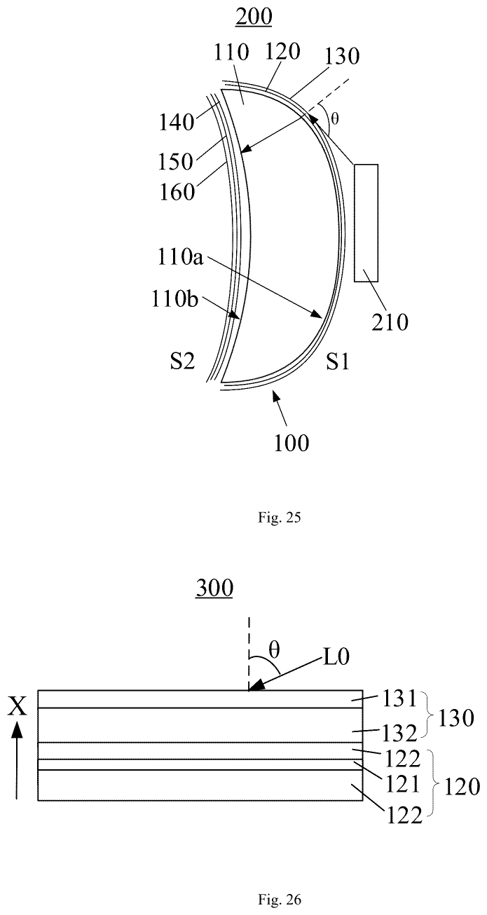

Embodiments of the present disclosure provides a display device. FIG. 25 is a cross-sectional schematic diagram of a display device provided by an embodiment of the present disclosure. As illustrated by FIG. 25, the display device 200 includes a display screen 210 and any of the above-described optical structures 100; and the display screen 210 is located on the light incident side S1 of the optical structure 100. Thus, the display device 200 has advantageous effects corresponding to advantageous effects of the optical structure 100, and no details will be repeated here.

In some examples, as illustrated by FIG. 25, the display screen 210 includes a micro organic light emitting diode (microOLED) display screen. When the display screen is the micro organic light emitting diode (microOLED) display screen, the maximum incident angle θ of light emitted from the display screen 210 and incident to the beam splitting film 120 is relatively large, for example, the incident angle θ is larger than 20 degrees, for example, the incident angle θ is between 20 degrees and 50 degrees; through the optical structure 100 as described above, consistency of the transmittance of the P-polarized component and the transmittance Ts of the S-polarized component of the incident light can be improved, and the light-transmitting protective film 130 can protect the metal layer 121 of the beam splitting film 120, without affecting the broadband beam splitting characteristic of the beam splitting film 120.

For example, a size of the display screen 210 or the micro organic light emitting diode display screen is between 0.8 inches and 1.6 inches. For example, a diameter size of the lens of the lens structure 110 is in a range from 4 cm to 5 cm. For example, a ratio of the diameter size of the lens of the lens structure 110 to a diagonal size of the display screen 210 is greater than or equal to 1.5.

For example, the display device 200 may be a near-eye display device 200 for virtual reality (VR) or mixed reality (MR).

Embodiments of the present disclosure further provides a depolarization beam splitting structure. FIG. 26 is a partially enlarged cross-sectional schematic diagram of a depolarization beam splitting structure provided by an embodiment of the present disclosure. As illustrated by FIG. 26, the depolarization beam splitting structure 300 includes a beam splitting film 120 and a light-transmitting protective film 130 stacked with each other; and the light-transmitting protective film 130 is located on a surface of the beam splitting film 120 and is in contact with the beam splitting film 120. The beam splitting film 120 includes a metal layer 121 and at least one non-metal layer 122 stacked with the metal layer 121. The light-transmitting protective film 130 includes a structure layer 131; a refractive index of the structure layer 131 gradually decreases along the reference direction X; and the reference direction X is a direction in which the beam splitting film 120 points towards the light-transmitting protective film 130. The diagram schematically shows that the beam splitting film 120 includes the metal layer 121 and the plurality of non-metal layers 122; and the plurality of non-metal layers 122 are located on two sides of the metal layer 121, but this will not be limited in the embodiments of the present disclosure.

In the depolarization beam splitting structure provided by the embodiments of the present disclosure, the beam splitting film 120 includes the metal layer 121; since reflection and transmission of a metal material is not sensitive to polarization, when an incident angle θ of incident light L0 incident to the beam splitting film 120 is relatively large (e.g., when the incident angle θ is larger than 20 degrees), as compared with a medium beam splitting film, the beam splitting film 120 provided with the metal layer 121 can make a transmittance Tp of a P-polarized component and a transmittance Ts of an S-polarized component of the incident light L0 have a relatively small difference, and can improve consistency between the transmittance of the P-polarized component and the transmittance Ts of the S-polarized component of the incident light L0, which can reduce influence on an ellipticity of the incident light L0 and make the ellipticity of the incident light L0 as close to 1 as possible.

In this embodiment, the surface of the beam splitting film 120 is further provided with the light-transmitting protective film 130 in contact with the beam splitting film 120; and the light-transmitting protective film 130 can protect the metal layer 121 inside the beam splitting film 120, avoiding corrosion and oxidation of the metal layer 121 inside the beam splitting film 120. In addition, the light-transmitting protective film 130 includes the structure layer 131; the refractive index of the structure layer 131 gradually decreases along the reference direction X; the structure layer 131 can avoid interference fringes of the incident light on the structural layer 131, and prevent the light-transmitting protective film 130 from causing adverse effects on the reflection spectrum and the transmission spectrum of the beam splitting film 120. Therefore, the light-transmitting protective film 130 can protect the metal layer 121 of the beam splitting film 120, without affecting the broadband beam splitting characteristic of the beam splitting film 120.

In some examples, as illustrated by FIG. 26, the light-transmitting protective film 130 further includes a base layer 132; the base layer 132 is closer to the beam splitting film 120 than the structure layer 131; and the base layer 132 is in contact with the beam splitting film 120 and is configured to protect the beam splitting film 120. The base layer 132 of the light-transmitting protective film 130 can protect the metal layer 121 of the beam splitting film 120, isolate water vapor and oxygen in the air, and avoid corrosion and oxidation of the metal layer 121.

For example, the beam splitting film 120 and the light-transmitting protective film 130 in the depolarization beam splitting structure provided by the embodiments of the present disclosure are the same as the beam splitting film 120 and the light-transmitting protective film 130 in the optical structure 100 as described above, and no details will be repeated here.

For example, the depolarization beam splitting structure 300 may be used in a head-up display (HUD) scenario, etc.

There are several points which should be noted.

(1) In the drawings of the embodiments of the present disclosure, only the structures involved in the embodiments of the present disclosure are involved. Other structures can refer to the usual design.

(2) The features in the same embodiment and different embodiments of the present disclosure can be combined with each other without conflict.

The above are only the specific implementations of the present disclosure, but the scope of protection of the present disclosure is not limited thereto. Any person skilled in the art can easily conceive of variations or substitutions within the technical scope disclosed in the present disclosure, which should be included in the scope of protection of the present disclosure. Therefore, the scope of protection of the present disclosure shall be based on the scope of protection of the claims.

1. An optical structure, having a light incident side and a light-exiting side, comprising:
a lens structure, comprising a first surface and a second surface arranged opposite to each other; the first surface being a surface of the lens structure on the light incident side, and the first surface being a curved surface;
a beam splitting film, located on a side of the first surface away from the second surface;
a light-transmitting, located on a side of the beam splitting film away from the first surface and in contact with the beam splitting film;
a phase retardation film, located on a side of the second surface away from the first surface; and
a polarizing reflective film, located on a side of the second surface away from the first surface,
wherein the beam splitting film comprises a metal layer; the light-transmitting protective film comprises a structure layer; a refractive index of the structure layer gradually decreases along a reference direction; and the reference direction is a direction in which the beam splitting film points towards the light-transmitting protective film.

2. The optical structure according to claim 1, wherein the light-transmitting protective film further comprises a base layer; the base layer is closer to the beam splitting film than the structure layer; and the base layer is in contact with the beam splitting film and is configured to protect the beam splitting film.

3. The optical structure according to claim 2, wherein a refractive index of the base layer is not less than a maximum refractive index of the structure layer.

4. The optical structure according to claim 3, wherein the structure layer comprises a plurality of protruding structures; and along the reference direction, dimensions of cross-sectional line segments of a longitudinal section of each of the plurality of protruding structures gradually decreases, and a direction of each of the cross-sectional line segments is perpendicular to the reference direction, the longitudinal section is parallel to the reference direction.

5. The optical structure according to claim 4, wherein a lateral side of the longitudinal section of each of the plurality of protruding structures comprises at least one of a straight line segment or a curved line segment.

6. The optical structure according to claim 4, wherein a maximum height of each of the plurality of protruding structures in the reference direction ranges from 50 nm to 200 nm; and a minimum spacing distance between two adjacent ones of the plurality of protruding structures ranges from 0 nm to 200 nm.

7. The optical structure according to claim 1, wherein the refractive index of the structure layer decreases step by step along the reference direction, and comprises at least 3 decreasing steps.

8. The optical structure according to claim 7, wherein the structure layer comprises at least three structure sub-layers; the at least three structure sub-layers are sequentially arranged along the reference direction and refractive indices of the at least three structure sub-layers sequentially decrease along the reference direction.

9. The optical structure according to claim 8, wherein material densities of the at least three structure sub-layers sequentially decrease along the reference direction.

10. The optical structure according to claim 8, wherein each of the at least three structure sub-layers comprises a nanoparticle coating; and porosities of the at least three structure sub-layers sequentially increase along the reference direction.

11. The optical structure according to claim 2, wherein a material of the base layer of the light-transmitting protective film comprises at least one selected from the group consisting of acrylic, polyurethane, epoxy, amino resin, polyester resin, organosilicon, parylene and derivatives thereof, plasma-polymerized hexamethyldisiloxane, polytetrafluoroethylene, and polyvinylidene fluoride; and a material of the structure layer of the light-transmitting protective film comprises at least one selected from the group consisting of acrylic acid, polyurethane, epoxy, amino resin, polyester resin, organosilicon, parylene and derivatives thereof, plasma-polymerized hexamethyldisiloxane, polytetrafluoroethylene, and polyvinylidene fluoride.

12. The optical structure according to claim 2, wherein a thickness of the base layer ranges from 100 nm to 5 μm; and a thickness of the structure layer ranges from 50 nm to 200 nm.

13. The optical structure according to claim 1, wherein the beam splitting film further comprises at least one non-metal layer stacked with the metal layer.

14. The optical structure according to claim 1, further comprising:
a polarized absorption film, located on a side of the polarizing reflective film away from the first surface.

15. A display device, comprising a display screen and the optical structure according to claim 1, wherein the display screen is located on the light incident side of the optical structure.

16. The display device according to claim 15, wherein the display screen comprises a micro organic light emitting diode display screen.

17. A depolarization beam splitting structure, comprising a beam splitting film and a light-transmitting protective film stacked with each other;
wherein the light-transmitting protective film is provided in contact with the beam splitting film; the beam splitting film comprises a metal layer and at least one non-metal layer stacked with the metal layer; the light-transmitting protective film comprises a structure layer; a refractive index of the structure layer gradually decreases along a reference direction; and the reference direction is a direction in which the beam splitting film points towards the light-transmitting protective film.

18. The depolarization beam splitting structure according to claim 17, wherein the light-transmitting protective film further comprises a base layer; the base layer is closer to the beam splitting film than the structure layer; and the base layer is in contact with the beam splitting film and is configured to protect the beam splitting film, a refractive index of the base layer is not less than a maximum refractive index of the structure layer.

19. The depolarization beam splitting structure according to claim 18, wherein the structure layer comprises a plurality of protruding structures; and along the reference direction, dimensions of cross-sectional line segments of a longitudinal section of each of the plurality of protruding structures gradually decreases, and a direction of each of the cross-sectional line segments is perpendicular to the reference direction, the longitudinal section is parallel to the reference direction.

20. The depolarization beam splitting structure according to claim 17, wherein the refractive index of the structure layer decreases step by step along the reference direction, and comprises at least 3 decreasing steps, the structure layer comprises at least three structure sub-layers; the at least three structure sub-layers are sequentially arranged along the reference direction and refractive indices of the at least three structure sub-layers sequentially decrease along the reference direction.
